(19) United States
(12) Patent Application Publication
(10) Pub. No.: US 2011/0264558 A1
(43) Pub. Date: Oct. 27, 2011

(54) THIRD PARTY TRANSACTION PAYMENT PROCESSING

(76) Inventor: Alexandros P. Alexandrou, Richardson, TX (US)

(21) Appl. No.: 13/091,884

(22) Filed: Apr. 21, 2011

Related U.S. Application Data
(60) Provisional application No. 61/328,074, filed on Apr. 26, 2010.

(51) Int. Cl. G06Q 30/00

(52) U.S. Cl. 705/26.41

(57) ABSTRACT

Methods and apparatuses for paying for items offered for sale are discussed herein. An example method may include a customer accepting a merchant's offer for sale of a product, the customer paying a third party for the product, and the third party facilitating the payment for the product to the merchant.

### CROSS-REFERENCE TO RELATED APPLICATION

This patent application claims priority to U.S. Provisional Patent Application No. 61/328,074, filed Apr. 26, 2010, titled “THIRD PARTY TRANSACTION PAYMENT PROCESSING,” which is hereby incorporated by reference in its entirety.

### FIELD

The present invention relates to paying for an item and receiving payment of an item and, more particularly, methods, apparatuses, systems, computer readable media, and other means for involving a third party in the payment of the item.

### BACKGROUND

Online shopping has become increasingly popular as more people become comfortable navigating the Internet. To purchase an item online, a customer will often provide a, credit card, debit card, or checking account number to the merchant. Similarly, a number of customers often pay credit card companies, banks, and other loan providers electronically. However, industry would benefit from other types of systems, methods, and means that may be employed to receive and process payment for goods and services purchased from an e-commerce merchant.

### BRIEF SUMMARY

Embodiments discussed herein include a bill pay system and method as well as computer readable media and other means for allowing a merchant (e.g., online retailer, telemarketer, infomercial producer, utility company, service provider, landlord, etc.) to provide its customers the ability to use an unaffiliated retail store, kiosk, or other payment system to pay for a product provided by the merchant. The merchant may send (via email, text message, regular mail, and/or over the telephone) a code that the customer may physically take and/or otherwise provide (e.g., electrically transmit) to a payment system at a payment location. At the payment location, the code can be inputted into one or more payment systems, and be used to process an in-person payment for the product. Because the exchange of money and/or other type of payment transaction occurs in-person between the customer and a third party (as opposed to remotely between a customer and merchant), the customer may purchase the online item using cash as well as any other form of payment (e.g., credit card, debit card, etc.).

For example, at the payment location, a computer system can receive, decipher and/or otherwise “read” the code (e.g., barcode, numeric code, etc.) provided by the customer, and determine that payment amount paid by the customer has been accepted. The payment system can include or otherwise communicate with one or more backend systems that can validate the cost of the item, and notify the merchant the payment was received. The merchant may then initiate the release of the product to the customer (e.g., ship goods and/or perform service).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B show a system that may allow a customer to order a product from a remote merchant and conduct in-person payment(s) for the product in accordance with some example embodiments of the present invention;

FIG. 2 show a block diagram of components that may be included in an example payment system in accordance with some example embodiments of the present invention;

FIG. 3 show a block diagram of components that may be included in an example authorizer system in accordance with some example embodiments of the present invention;

FIG. 4 show a block diagram of components that may be included in an example payment host in accordance with some example embodiments of the present invention; and

FIGS. 5-8B show flow diagrams in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments discussed herein provide third party payment methods, apparatuses systems, computer readable media, and other means for enabling a customer, who would like to buy an item online, over the telephone, etc., but pay for the item in-person at a physical location of a third party. For example, after selecting a product (e.g., at least one good and/or service) online for purchase, rather then enter a credit card or other type of account information online with the merchant, the customer may indicate he would like to pay a third party in-person. The system may then generate a code for the transaction and send it to the customer. The customer may provide the code to a third party and pay for the item using cash and/or any other type of in-person payment accepted by the third party.

As another example, rather than selecting at the time of offer acceptance to pay a third party in-person, customers may automatically receive a code on their invoices (e.g., for a utility service). The customer may then choose at time of payment to pay a third party (e.g., at a gas station or mall kiosk owned and/or operated by a third party), instead of the merchant directly. As referenced herein, a third party is an entity that is independent from the merchant (e.g., different business entity) and, in some embodiments, would not otherwise be involved in selling the goods or services of the merchant.

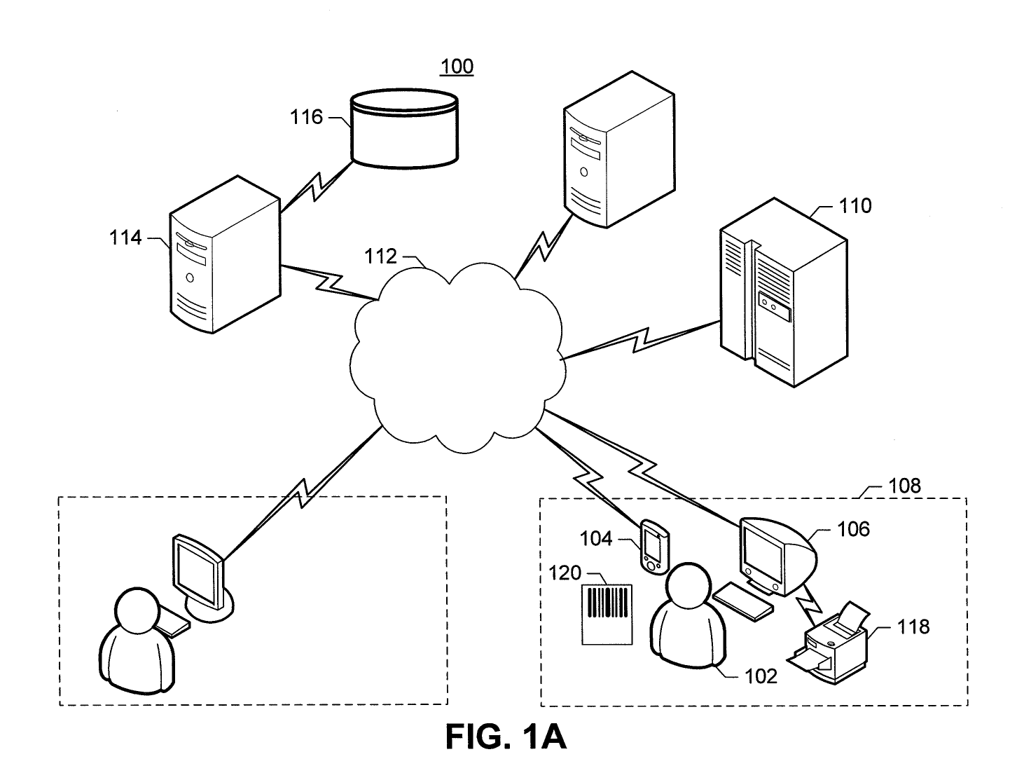

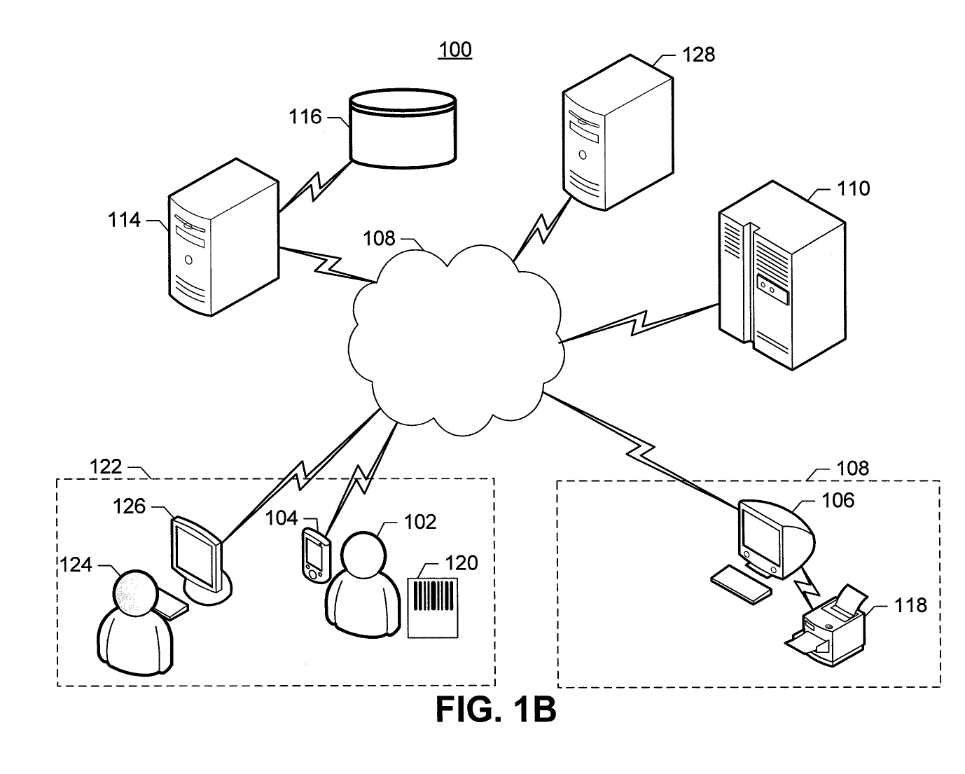

FIGS. 1A and 1B show system 100 which may allow customer 102 to conduct in-person payments for goods and/or services previously ordered by customer 102. For example, system 100 may be used to enable a third party to complete a transaction in-person after a merchant's offer for sale and customer 102's acceptance of the offer. The offer and acceptance may occur independent of the third party (e.g., without the third party's involvement or knowledge). As used herein, a “remote offer for sale” is distinguished from, for example, an in-person offer for sale, where a remote offer for sale involves the offer for sale being made over a network and/or with at least one communication device (e.g., telephone, computer, television, etc.), while an in-person offer for sale involves the offer being made in-person. The “offer for sale” as used herein can be distinguished from, for example, the payment of a product. An in-person payment, as referenced herein, may be made over a network (such as a those used by credit card payment system) even when the purchase is made in-person (e.g., a payment is personally handed to a sales clerk).

Customer 102 may use a customer machine, such as mobile device 104 and/or electrical machine 106, which can be configured to run executable code stored on machine-readable storage device(s). Mobile device 104 may include, for example, a cellular telephone, a personal digital assistant, a tablet computer, a laptop computer, and/or any other type of mobile device that may have network access. Electrical machine 106 may be any type of network device that may be less mobile than mobile device 104, such as, for example, a desktop computing device in a home, office or public space (e.g., library, computer café, etc.), traditional television, an integrated automobile system, among other electrical machines that may have network access.

Each device, system and/or other component shown in the drawings may represent a plurality of devices, systems and/or components. For example, while only one mobile device 104 and only one electrical machine 106 is shown in FIG. 1A to avoid overcomplicating the drawing, customer 102 may have multiple mobile devices and/or electrical machines that may be used and/or be included in system 100. As another example, payment host 114 (discussed below) may be a cluster of servers, a super computer, and/or one or more other electrical devices that can be configured to operate as described herein.

Customer 102 may use mobile device 104 and/or electrical machine 106 at physical location 108. Physical location 108 may be a home, an office building, an internet café, a public library, an automobile (or any other form of transportation, such as a bus, train or airplane), and/or any other location where customer 102 may use any type of mobile device 104 and/or electrical machine 106.

Mobile device 104 and/or electrical machine 106 may enable customer 102 to shop for goods and services offered for sale by an e-merchant or other type of retailer located remotely from the user. “Retailer,” as referenced herein, includes any purveyor of goods and/or services. For example, a retailer may use a website or television commercial to offer goods or services for sale. Merchant server 110 may be configured to serve the website and/or broadcast the television commercial to mobile device 104 and/or electrical machine 106 over network 112. Network 112 may comprise any type of wired and/or wireless network(s), including the Internet, WLAN, cellular network, WiMAX network, LTE network, cable network, broadcast television network, among others. Merchant server 110 may include, for example, a network server and/or any other type of device configured to execute instructions for providing a remote offer for sale to customer 102. In some embodiments, the product may be offered for sale directly from the owner of the product, in which case the owner may be associated with merchant server 110. In some other embodiments, the product may be offered for sale by a commerce company, marketing company, and/or any other type of company hired or otherwise used by the owner of the product to offer the product for sale. In such embodiments, the company may be associated with merchant server 110. If a product is sold, embodiments of the present invention can be configured to provide payment to the owner of the product, the marketing company, or both.

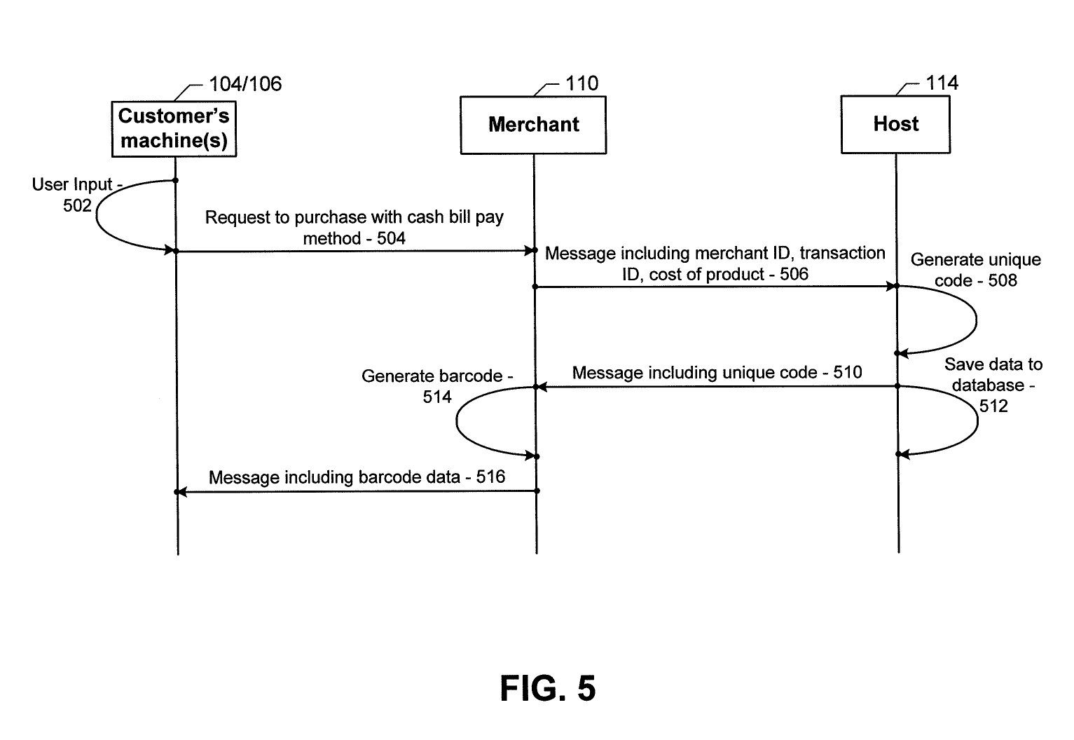

While customer 102 is shopping for goods or services remotely offered for sale, the customer's machine can be configured to generate and transmit a request that the online purchase be completed with the third party payment method described herein (which is discussed further in connection with, e.g., FIGS. 5-8B). For example, the customer's machine can be programmed to display a webpage that includes an option or other type of selectable offer to use the third party payment method to pay for a purchase. In response to receiving an indication of a user's selection of the option, mobile device 104 may generate and transmit a request that the online purchase be completed with the third party payment method. In response to receiving the request from the customer's machine, merchant server 110 can be configured to generate and transmit a request to a bill payment host, such as payment host 114, over network 112. The request generated and sent by merchant server 110 of the e-merchant can include, for example, the e-merchant's merchant identifier (“ID”), a transaction ID for the purchase, and/or the purchase amount.

In some embodiments, the request transmitted from merchant server 110 to payment host 114 can also include information identifying customer 102. For example, the customer's name, address, zip code, telephone number, internet protocol address (of e.g., mobile device 104 and/or electrical machine 106), e-mail address, user name, and/or other customer information can be transmitted.

In response to receiving the request from the e-merchant, payment host 114 can be configured prepare a unique value, such as a 13 digit alphanumeric code, an image-based code, and/or other type of code, to identify the transaction selected for third party payment. Payment host 114 can also be configured to transmit the unique value back to merchant server 110. In some embodiments, payment host 114 can also be configured to store locally and/or externally in database 116 the unique value, merchant ID, transaction ID, purchase amount, customer information, and/or any other data related to the transaction.

The unique value can be converted into and/or transmitted as a barcode, other type of machine-readable code, human-readable code, other type of encrypted or non-encrypted code, or combination thereof. For example, merchant server 110 may be configured to generate a barcode based on the data received from payment host 114. As another example (although not shown), the barcode generation may be executed by payment host 114, in which case payment host 114 may transmit the barcode to the e-merchant, rather than or in addition to the unique value. Merchant server 110 can be configured to transmit the barcode and/or unique value to one or more of the customer's machines. In some embodiments, payment host 114 may transmit the barcode and/or unique value to one or more of the customer's machines instead of or in addition to transmitting the barcode, unique value, and/or other type of code to merchant server 110.

Upon receiving the barcode, unique value, and/or other type of code at physical location 108 (and/or elsewhere), customer 102 may, for example, use printer 118 to create printout 120, which may include a barcode and/or other type of code received by the customer's device. For example, in addition to or instead of a barcode, printout 120 may include a numerical code, an encoded radio frequency identification tag, a picture, and/or any other type of indicia (including visible, invisible and/or electronically stored indicia). In some embodiments, customer 102 may download and/or otherwise receive the code with mobile device 104 and/or electrical machine 106, which may be configured to convert the code into a barcode and/or other machine-readable code if necessary.

As shown in FIG. 1B, customer 102 may travel to payment location 122 and make a cash and/or other type of in-person payment for the product (e.g., good and/or service) customer 102 would like to purchase from the e-merchant. In addition to or instead of cash being used to pay at the physical location, one or more credit cards, checks (e.g., personal checks, traveler's checks, etc.), other types of currency, any other method of payment (including bartering), or combination thereof can be received at payment location 122 to complete the transaction between customer 102 and the e-merchant.

Payment location 122 may be, for example, a bricks-and-mortar retail site (e.g., shopping mall, restaurant, food store, etc.), automated teller machine (“ATM”), gas station, kiosk, utility company, dedicated payment center, government building, and/or any other physical location that may accept payment for the purchase of a product in-person. Customer 102 may provide the code to payment clerk 124. For example, customer 102 may use printout 120, mobile device 104, an oral description of the code, and/or any other means to convey the code to payment clerk 124. In some embodiments, payment system 126 may be configured to scan, image, and/or otherwise electrically read and/or otherwise directly receive the code from printout 120 and/or mobile device 104. Payment system 126 may include, for example, a cash register, computer, credit card machine, barcode scanner, RFID reader, BlueTooth® (“BT”) transceiver, camera, audio recorder, and/or any other device that is configured to extract product information, sale information, and/or any other information represented by the code that may aid in facilitating the sale of the product remotely offered for sale.

In some embodiments, in addition to or instead of receiving the code from customer 102, payment system 126 may receive customer information from the customer. The customer information can be obtained by scanning or otherwise receiving driver's license information, by customer 102 telling payment clerk 124, and/or by any other means (manual, automatic, and/or otherwise).

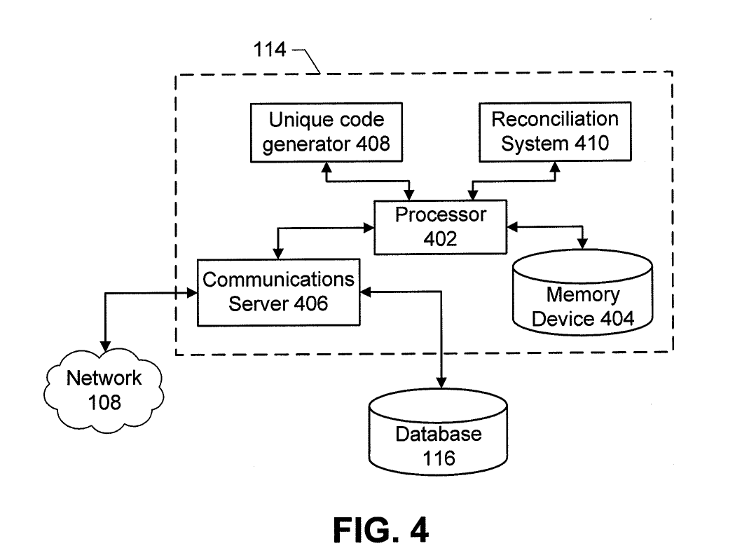

In response to receiving the code and/or customer information, payment system 126 can be configured to transmit the code, customer information and/or data derived from the code from payment location 122 to payment host 114 and/or another device that is an approved authorizer machine of the third party payment system. As discussed further in connection with FIGS. 3 and 4, the authorizer machine can be located at a location remote from payment location 122 (e.g., at payment host 114), at the same location as payment location 122 (e.g., included in payment system 126), or dispersed among machines operating at a plurality of locations (remote and/or local to payment location 122). The authorizer machine can request verification of the unique value and/or other data from the payment host 114, database 116 and/or any other host device. In response to the unique value and/or other data (e.g., customer information) being located, identified and/or validated based on data stored by one or more host devices, payment host 114 can be configured to generate and transmit a verification, approval, purchase order, and/or other type of message, which may include the amount of the purchase, to a customer device (e.g., mobile device 104), to payment system 126, to another authorizer machine, and/or to any other device. If the authorizer machine is not located at payment location 122, the authorizer machine can be configured to generate and transmit to payment location 122 the required purchase amount, the unique value, and/or any other purchase data.

Although many of the examples provided hereinafter reference a code that the customer provides to the payment system, customer information may also be used to compliment or replace the code. For example, customer information may be used by system 100 to verify the identity of customer 102, determine transaction information (e.g., the amount owed) associated with customer 102, and/or enable system 100 to receive a third party payment from customer 102 to complete the purchase transaction. In this regard, customer information may be used if customer 102 is unable to print out a barcode, loses the barcode, payment host 114 malfunctions (e.g., when generating and/or storing the code), or otherwise there is no identifiable code generated by payment host 114 and/or other device.

Payment may be made in-person by customer 102 at the payment location 122. A message may be generated by payment system 126 that indicates and confirms the in-person payment and completion of the purchase by customer 102. Payment system 126 may transmit the message to payment host 114 and/or a remotely located the authorizer machine. If the authorizer machine is separate from payment host 114, the authorizer machine may be configured to re-transmit the message, and/or data derived from the message (including, for example, the purchase amount, the unique value and/or any other purchase data) to a host device, such as payment host 114, for further processing.

The host device may then process the cash or other type of in-person payment purchase for the e-merchant associated with merchant server 110. In some embodiments, each in-person payment purchase can be executed one transaction at a time and independent of other in-person payment purchases. In some embodiments, the host may consolidate and/or group multiple transactions, which may be related (e.g., associated with the same e-merchant), that are ready for payment processing can be issued for reconciliation and consolidation into a single automated clearing house (“ACH”) payment and/or other type of request, thereby minimizing, for example, ACH processing fees. The host device may also transmit payment confirmation to the associated e-merchant(s). Additionally or alternatively, payment host 114 may consolidate a first group of transactions, in response to receiving one or more payment confirmation messages, into a first bundle and notify the e-merchant of payments being received for the first bundle of transactions without notifying a bank or otherwise transferring funds. After one or more bundles of transactions have been created (and/or provided to the e-merchant), after a predetermined period of time, and/or after receiving a request from the e-merchant, the host may then consolidate one or more bundles of payment confirmation messages into a combined balance payment. For example, a single ACH transaction (less any processing fees) may be used to transfer funds for the combined balance payment. The e-merchant(s) may also be notified of the combined balance payment. For example, the e-merchants may receive a report identifying each transaction associated with the combined ACH transaction.

For example, single consolidated ACH payment request can be generated by a host device, such as payment host 114, and transmitted from the host device to a bank machine or other appropriate financial clearinghouse, such as bank system 128. The single consolidated ACH payment request can be reduced by the amount of the processing fees assessed by payment host 114, other host, and/or authorizer machine and by the processing fees, if any, of associated with payment system 126 at payment location 122, if such processing fees were not collected at payment location 122 at the time the payment was received from customer 102. Bank system 128 can be configured to, e.g., execute an electronic transfer of funds for the purchased items (e.g., goods or services) to the e-merchant associated with merchant server 110.

Upon receipt of either the payment confirmation from host 114 and/or the funds from bank system 128, the e-merchant (such as merchant server 110) completes the purchase transaction, such as by causing the shipment of the goods and/or providing of the services purchased by customer 102 to customer 102 or other recipient of customer 102's purchase.

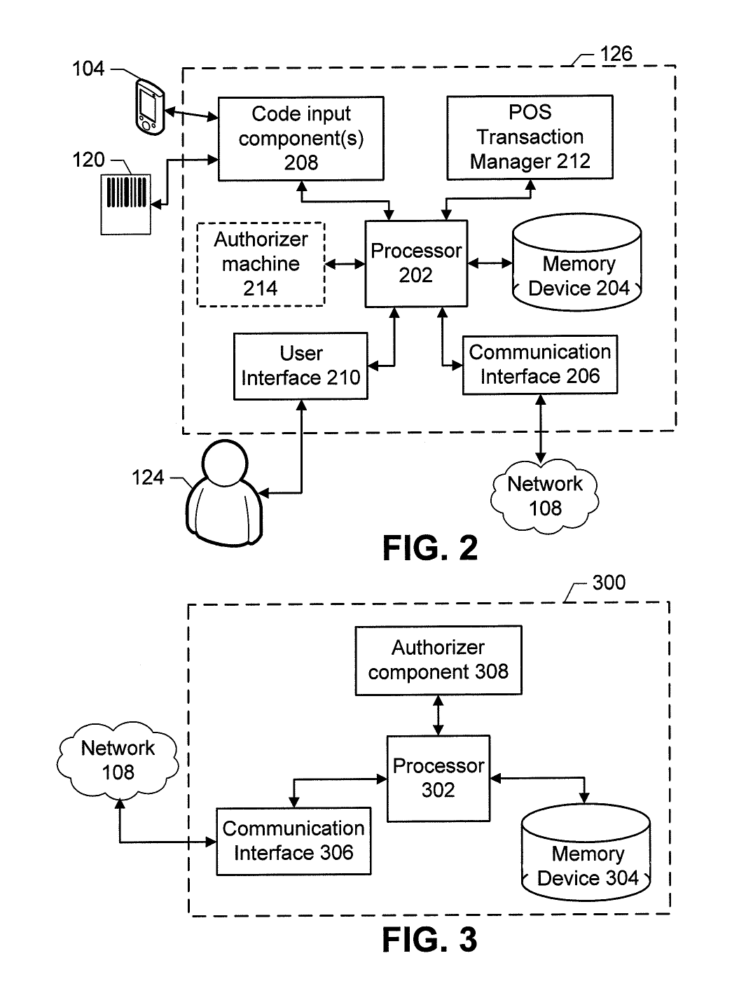

FIG. 2 shows a structural block diagram of circuitry and other components that may be included in payment system 126 discussed in connection with, e.g., FIGS. 1A and 1B. According to various example embodiments, payment system 126 may be, or be included within a computing device that supports and/or utilizes network communications and configured as described above to perform its functionality.

Payment system 126 may include processor 202, which may be embodied as various means for implementing various functionality of example embodiments of the present invention including, for example, microprocessors, coprocessors, controllers, special-purpose integrated circuits such as, for example, ASICs (application specific integrated circuits), FPGAs (field programmable gate arrays), or hardware accelerators, processing circuitry or the like. According to some example embodiments, processor 202 may be representative of a plurality of processors operating in concert. Processor 202 may, but need not, include one or more accompanying digital signal processors. In some example embodiments, processor 202 is configured to execute instructions stored in memory device 204 or instructions otherwise accessible to the processor 202. Whether configured as hardware or via instructions stored on a computer-readable storage medium (such as memory device 204), or by a combination thereof, processor 202 may be an entity capable of performing actions according to embodiments of the present invention while configured accordingly. Thus, in example embodiments where processor 202 is embodied as an ASIC, FPGA, or the like, processor 202 is specifically configured hardware for conducting the actions described herein. Alternatively or additionally, in example embodiments where processor 202 is embodied as an executor of instructions stored on a computer-readable storage medium, the instructions specifically configure processor 202 to perform the algorithms and actions described herein. In some example embodiments, processor 202 is a processor of a specific device (e.g., payment system 126) configured for employing example embodiments of the present invention by further configuration of processor 202 via executed instructions for performing the algorithms and actions described herein.

Payment system 126 may include memory device 204, which may comprise one or more computer-readable storage media, such as volatile and/or non-volatile memory. Memory device 204 may be contrasted with a computer-readable transmission medium, such as a propagating signal. In some example embodiments, memory device 204 comprises random access memory (“RAM”) including dynamic and/or static RAM, on-chip or off-chip cache memory, and/or the like. Further, memory device 204 may comprise non-volatile memory, which may be embedded and/or removable, and may comprise, for example, read-only memory, flash memory, one or more magnetic storage devices (e.g., hard disks, floppy disk drives, magnetic tape, etc.), optical disc drives and/or media, non-volatile random access memory (NVRAM), and/or the like. Memory device 204 may comprise a cache area for temporary storage of data. In this regard, some or all of memory device 204 may be included within processor 202.

Further, memory device 204 may be configured to store information, data, applications, computer-readable program code instructions, or the like for enabling processor 202 to carry out various functions in accordance with example embodiments of the present invention described herein. For example, memory device 204 could be configured to buffer input data for processing by processor 202. Additionally, or alternatively, memory device 204 may be configured to store instructions for execution by processor 202.

Payment system 126 may include communication interface 206 and/or code input component 208, which may be any device or means embodied in either hardware, a computer program product, or a combination of hardware and a computer program product that is configured to receive and/or transmit data from/to a network and/or any other device or module in communication with the payment system 126. Processor 202 may also be configured to facilitate communications via communication interface 206 and/or code input component 208 by, for example, controlling hardware included within the respective components. In this regard, communication interface 206 and/or code input component 208 may comprise, for example, one or more antennas, a transmitter, a receiver, a transceiver and/or supporting hardware, comprising a processor for enabling communications with network 108, mobile device 104, printout 120, and/or any other device and/or indicia. Via communication interface 206 and/or code input component 208 and network 108, payment machine 126 may communicate with various other network entities and/or receive various inputs in a device-to-device fashion and/or via indirect communications via a base station, access point, server, gateway, router, or the like.

Communication interface 206 may be configured to provide for communications in accordance with any wired or wireless communication standard or communications technique. For example, the communications interface may be configured to communication using techniques involving radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BT, and/or the like. And code input component 208 may include, for example, hardware, software, and/or firmware configured to operate as a barcode scanner, RFID reader, imaging device, BT, microphone, and/or any other type of code input component(s).

User interface 210 may be in communication with processor 202 to receive user input(s) from, for example, payment clerk 124. For example, user interface 210 may include hardware, software and/or firmware for a keyboard, mouse, track pad, multi-touch screen, microphone, camera, and/or any other input component with which payment clerk 124 may interact. User interface 210 may also be configured to present output to a user. For example, user interface 210 may include hardware, software and/or firmware for a display (e.g., a touch screen display), a speaker, and/or any other type of audible, visual, mechanical (including tactile) that can provide output indications to a human.

Point of sale (“POS”) transaction manager 212 of payment system 126 may be any means or device embodied, partially or wholly, in hardware, a computer program product, or a combination of hardware and a computer program product, such as processors 202 implementing stored instructions to configure payment system 126, or hardware configured processors 202, that is configured to carry out the functions of payment system 126 as described herein. In an example embodiment, processor 202 includes, or control, POS transaction manager 212. The POS transaction manager 212 may be, partially or wholly, embodied as a processor similar to, but separate from processor 202. In this regard, the POS transaction manager 212 may be in communication with the processor 202. In various example embodiments, the POS transaction manager 212 may, partially or wholly, reside on distributed apparatuses such that some or all of the functionality of the POS transaction manager 212 may be performed by a first apparatus, and the remainder of the functionality of POS transaction manager 212 may be performed by one or more other apparatuses. For example, POS transaction manager 212 may include a credit card reader, RFID reader, cash register, keypad, and/or any other component that may be used at point of sale to receive payment.

Payment system 126 may also include authorizer machine 214. Authorizer machine 214 may be any means or device embodied, partially or wholly, in hardware, a computer program product, or a combination of hardware and a computer program product, such as processors 202, or hardware configured processors 202, that is configured to carry out the functions of payment system 126 as described herein, including those described above in connection with FIG. 1B. In an example embodiment, processor 202 includes, or control, authorizer machine 214. Authorizer machine 214 may be, partially or wholly, embodied as a processor similar to, but separate from processor 202. In this regard, authorizer machine 214 may be in communication with the processor 202.

In various example embodiments, the authorizer machine may partially or wholly reside on distributed apparatuses such that some or all of the functionality of the authorizer machine 214 may be performed by a first apparatus (such as payment system 126), and the remainder of the functionality of the authorizer machine 214 may be performed by one or more other apparatuses.

For example, as shown in FIG. 3, authorizer machine 300 may communicate with one or more payment systems, such as payment system 126. Authorizer machine 300 may include processor 302, which may be any type of processor and/or function as or similar to processor 202 discussed above. Authorizer machine 300 may also include memory device 304 which may be any type of memory and/or function as or similar to memory device 204 discussed above, and communication interface 306 which may be any type of communication interface and/or function as or similar to communication interface 206 discussed above. Authorizer machine 300 may also include authorizer 308, which can be hardware, software, and/or firmware configured to communicate with and perform authorizing functionality for one or more payment systems, such as all the payment systems at a given payment location, such as payment location 122. Payment system 300 may also be located remotely from the payment location.

Authorizer machine 214 and/or authorizer 308 may be configured to, for example, generate a message to a host device that includes, for example, a unique code received by code input component 208. In response, authorizer machine 214 and/or authorizer machine 300 may receive an approval or denial of the code and/or an associated purchase amount that should be or should have been received by POS transaction manager 212. In response to receiving a confirmation that POS transaction manager 212 has received payment for the identified purchase amount, authorizer machine 214 and/or authorizer machine 300 can transmit a payment confirmation message to the host device.

FIG. 4 shows a structural block diagram of circuitry and other components that may be included in payment host 114 discussed in connection with, e.g., FIGS. 1A and 1B. According to various example embodiments, payment host 114 may be, or be included within a computing device that supports and/or utilizes network communications and configured as described above to perform its functionality.

For example, payment host 114 may include processor 402, which may be any type of processor and/or function as or similar to processor 202 discussed above. Payment host 114 may also include memory device 404 which may be any type of memory and/or function as or similar to memory device 204 discussed above.

Communications server 406 of payment host 114 may be, for example, a network server that includes one or more communication interfaces similar to those discussed above and/or be more robust than communications interface 206 discussed above. Communications server 406 may also be configured to handle a higher volume and more complicated network traffic than, for example, communications interface 306 and/or communication interface 206. In other embodiments, communications interface 306 and/or communication interface 206 are configured to function as a server similar to or the same as communications server 406.

Payment host 114 may also include unique code generator 408, which can be hardware, software, and/or firmware configured to generate a unique code associated with acceptance of a products offer for sale. In some embodiments, unique code generator 408 may, partially or wholly, embodied in processor 402. Alternatively or additionally, unique code generator 408 may be separate from processor 402. In this regard, unique code generator 408 may be in communication with the processor 402. Examples of unique code(s) that may be generated by unique code generator 408, including a unique 13 digit code, are discussed above in connection with, e.g., FIGS. 1A and 1B.

Payment host 114 may also include reconciliation system 410, which can be hardware, software, and/or firmware configured to reconcile one or more payment confirmation messages to reduce costs, such as, e.g., ACH processing fees. For example, in addition to that discussed in connection with FIG. 1B and the drawings below, reconciliation system 410 can be configured to receive a data input representing multiple transactions facilitated by various third parties (such as payment system 126), and consolidate the transactions into a single consolidated output transaction that can be sent to a bank and/or merchant. As another example, reconciliation system 410 can be configured to receive a fist data input representing one or more transactions facilitated by various third parties (such as payment system 126), and consolidate the transactions into a single consolidated output transaction that can be sent to a merchant, so the merchant knows that the payment has been received by the third party and may begin providing the purchased product. Reconciliation system 410 can then receive one or more additional data inputs representing additional groups of transactions facilitated by various third parties (such as payment system 126), output a consolidated transaction to the merchant for each group of transactions, and subsequently consolidate the plurality of groups of transactions into a single output balance payment transaction to a bank or other clearinghouse associated with the merchant.

In this regard, a bank may receive a consolidated ACH payment (less host and/or authorizer processing fees) and/or a merchant may receive a consolidated account payment for various products purchased during a predetermined period of time (e.g., over the past hour, day, week, etc.) that now need to be fulfilled by the merchant. In some embodiments, reconciliation system 410 may, partially or wholly, embodied in processor 402. Alternatively or additionally, reconciliation system 410 may be separate from processor 402. In this regard, reconciliation system 410 may be in communication with the processor 402.

FIGS. 5-8B show flow diagrams in accordance with some exemplary systems, methods and/or computer program products discussed herein, including those shown in FIGS. 1-4. It will be understood that each action, step and/or other types of actions shown in the diagrams, and/or combinations of actions in the diagrams, can be implemented by various means. Means for implementing the actions of the diagrams, combinations of the actions in the diagrams, or other functionality of example embodiments of the present invention described herein may include hardware, and/or a computer program product including a computer-readable storage medium (as opposed to or in addition to a computer-readable transmission medium) having one or more computer program code instructions, program instructions, or executable computer-readable program code instructions stored therein. In this regard, program code instructions may be stored on a memory device of an example apparatus and executed by a processor, such as those discussed above. As will be appreciated, any such program code instructions may be loaded onto a computer or other programmable apparatus (e.g., processors 202, processors 402, or the like) from a computer-readable storage medium (e.g., memory 204, memory 404, or the like) to produce a particular machine, such that the particular machine becomes a means for implementing the functions specified in the diagrams' actions shown in FIGS. 5-8B.

These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the diagrams' actions. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide actions for implementing the functions specified in the diagrams' actions.

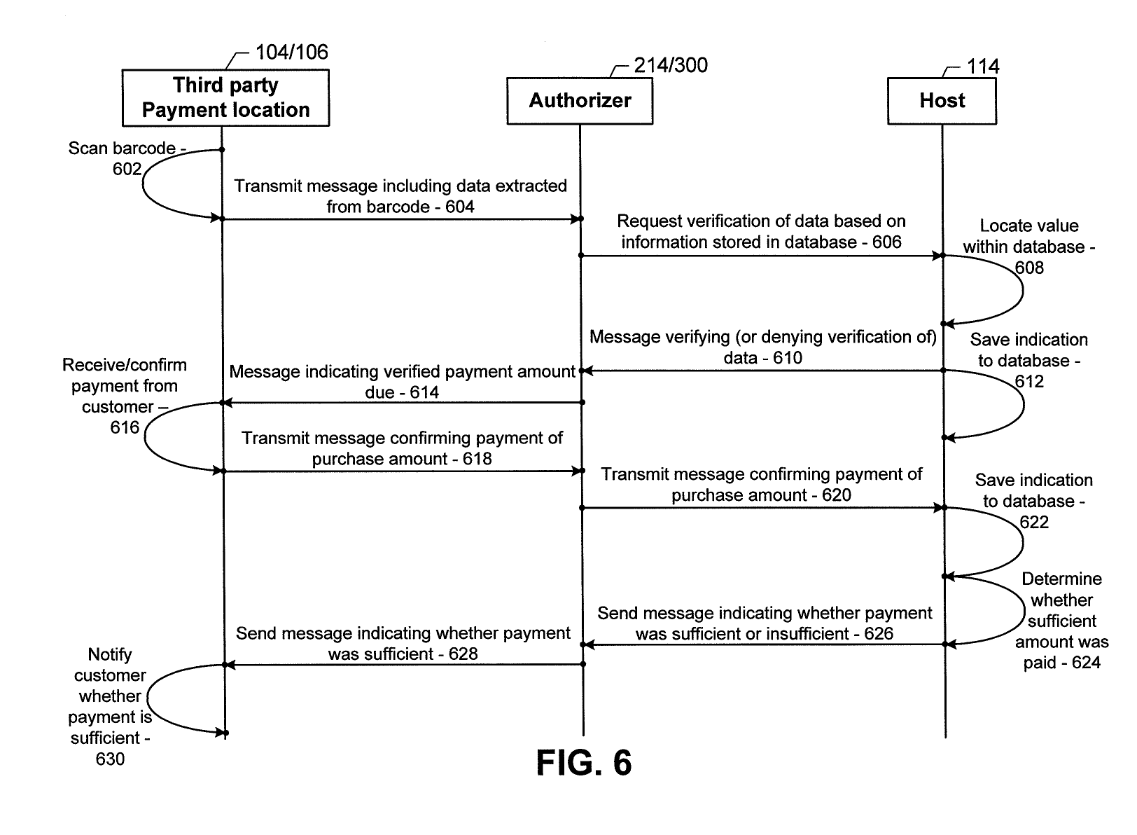

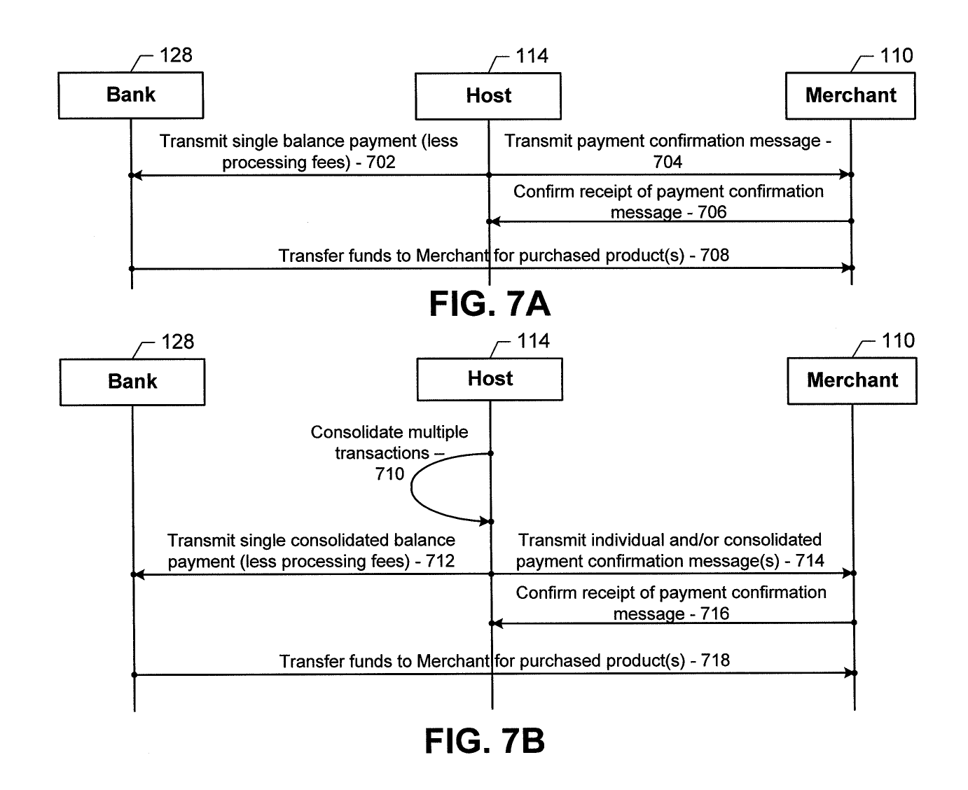

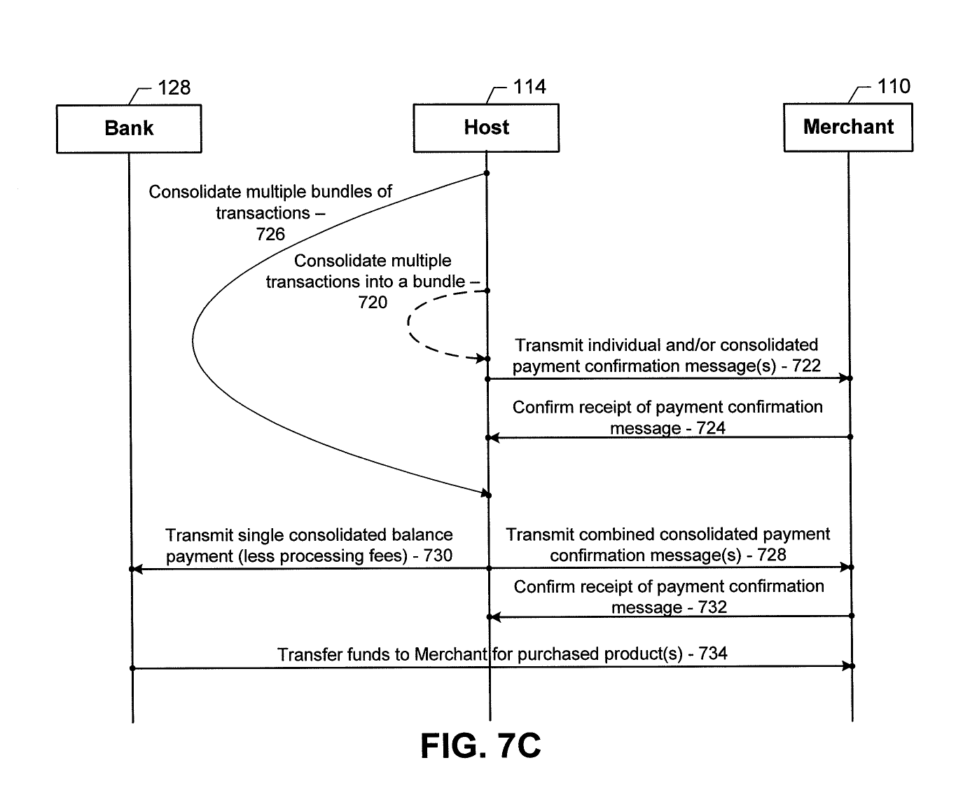

In some embodiments, the actions shown in FIGS. 5, 6 and 7 can be executed sequentially, where the actions of FIG. 5 precede those of FIG. 6, which precede those of FIG. 7. At 502, a customer machine, such as mobile 104 and/or electrical machine 106, may receive a user input. For example, the customer machine may be displaying a website that is offering a product (e.g., good(s) and/or service(s)) for sale. The customer machine may receive a user selection of the product and/or any other indication of the customer's desire to purchase the product. The customer machine may also receive a user's indication to purchase the product by using a third party payment method in accordance with some embodiments. As discussed herein, the third party payment method refers to the purchasing of a product made available for sale by a remote merchant by paying for the product in-person to a third party. For example, the customer may be using a computer at an internet café or in a public library to buy an item online, but the customer does not feel comfortable entering his credit card or other account number into the public computer to pay for the item. As another example, some merchants may choose to not accept payments online and instead opt to only use the third party payment method discussed herein to avoid fraud.

The customer's machine can be configured to generate and, at 504, send a message to the merchant (e.g., to merchant server 110) requesting and/or otherwise indicating that the online purchase be completed with the third party payment method. For example, the customer's machine can be programmed to display a webpage that includes a selectable option or other indication to use the third party payment method, only in response to determining the third party payment method functionality is available by the merchant.

In response to receiving the request, the merchant can be configured to generate and transmit at 506 a message including a request to use the third party payment method supported by the host device (e.g., payment host 114). The request generated by the merchant can include, for example, the merchant's merchant ID, a transaction ID for the purchase, the cost amount of the purchase, customer information, information associated with the customer's desired/preferred payment location, and/or any other information.

In response to receiving the request from the merchant, the host can be configured generate, at 508, a unique value to identify this specific transaction during the execution of the third party payment method. For example, the unique code can comprise as a 13 digit alphanumeric image-based code and/or other type of code.

At 510, the host may transmit the unique value back to the merchant's device. For example, the host may transmit a 13 digit number, an alphanumeric code, and/or any other type of code to the merchant. The host can also be configured to, e.g., store, at 512, the unique value, merchant ID, transaction ID, purchase amount, customer information, desired third party payment location, and/or any other information in a computer readable storage device (such as database 116 and/or memory 404).

In response to receiving the unique code, the merchant can be configured to generate, at 514, a barcode, other type of machine-readable code, human-readable code, other type of encrypted or non-encrypted code, or combination thereof that is associated with and/or based on the barcode. For example, the generation of a barcode may occur at the merchant as shown in FIG. 5. As another example (although not shown), the barcode generation may occur at the host, in which case the host would transmit the barcode (e.g., bitmap data of a barcode, etc.) to the merchant at 510, rather than or in addition to the unique value. At 516, the merchant can provide the customer with the barcode to use in completing the online purchase.

Subsequently thereafter, as shown in FIG. 6, the customer (e.g., customer 102) can travel to a third party location (such as payment location 122) and present the barcode and/or other type of code. A system at the third party location, such as payment system 126, can be configured to scan, image, etc. and the code at 602. The payment system can also be configured to extract data from the barcode. The extracted data can be related to the product and/or other information associated with the purchase from the merchant used to generate the code.

The third party payment location may then generate a message from the extracted data and, at 604, transmit the message to an authorizer (e.g., authorizer system 214 and/or authorizer system 300). The authorizer machine can be located, for example, at a location remote from the physical location, at the same location as the physical location (e.g., including a machine operating at the physical location), and/or dispersed among machines operating at a plurality of locations (remote and/or local to the physical location visited by the customer).

At 606, the authorizer can request, from the host, verification of the data (including, e.g., the unique value) that the host stored in its storage medium. In response to the unique value being located at 608, identified and/or validated based on data stored in the database, the host can be configured to generate and transmit at 610 a verification or other type of approval message, including, e.g., the amount of the purchase to the authorizer. At 612, an indication of the approval message being sent can be stored in the host's storage medium.

In some embodiments, rather than or in addition to extracting data from a code at 602, the payment system may receive customer information, such as name, address, telephone number, etc. The customer information may be transmitted at 604 with and/or instead of data extracted from a code presented by the customer. The customer information may then be used at 608 to verify the customer and determine the amount owed by the customer. The ability to use customer information to look up purchase information may help expedite the process for, among other situations, repeat customers and/or if the customer loses or is unable to provide a code to the payment clerk.

The authorizer can receive the message from the host and relay the message to the payment system. For example, if the authorizer servers a number of payment systems, the authorizer can be configured to generate a payment system specific message from a consolidated message received for the host. For example, the authorizer system may be configured to reformat data included in the message from the host, address the new message to a particular payment machine, and/or otherwise prepare a message that is suitable for a particular payment system. At 614, the authorizer may be configured to transmit to the third party's payment location the generated message verifying, e.g., the required purchase amount, the unique value, and/or any other purchase-related data that may have been stored and/or generated by the host and/or authorizer.

At 616, payment for the online and/or other type of purchase may be made by the customer and received at the physical location. In addition to or instead of cash being used to pay at the physical location, one or more credit cards, checks (e.g., personal checks, traveler's checks, etc.), other types of currency, any other method of payment (including bartering), or combination thereof can be employed to complete an online transaction.

The payment system may generate a message indicating confirmation of the payment for the product purchased remotely by the customer. At 618, the payment system may transmit the message from the physical location to the authorizer.

At 620, the authorizer can be configured to relay the message and/or data derived from the message to the host. For example, a confirmation of the payment may be re-transmitted, including the received purchase amount, code data and/or any other purchase data, from the authorizer to the host for further processing. At 622, an indication of the payment confirmation message can be stored in the host's storage medium.

In some embodiments, only a portion of the purchase price may be paid and/or required by the merchant. The host may have this information stored in a database. In response to receiving the message confirming the payment of the purchase amount, the host can be configured to determine, at 624, based on the payment confirmation whether the portion of the purchase price that was paid is sufficient to initiate providing of the product to the customer. For example, the amount paid may be sufficient to initiate the providing of a part of a product (such as a first service in a series of services) and/or the entire product (even though, for example, the payment is but one installment. A message may then be generated by the host and sent, at 626, indicating whether the payment received was sufficient or insufficient to facilitate the providing of the entire or a part of the product. The message may be relayed to the payment system at 628 and an indication of the payment's sufficiency may be displayed at 630. In some embodiments, for example, if additional information is included in the message sent at 628 (such as a notification that an additional payment is necessary, the amount that will still be due, any late fees that will be added thereto, etc.), that additional amount may also or instead be displayed at 630. In some embodiments, 624-630 may be omitted or combined with other operations discussed herein (e.g., such as 608-614).

Subsequently thereafter, as shown in FIGS. 7A, 7B and 7C, the system backend portion may facilitate final steps of the process, including confirming payment and possibly also initiating the providing of the purchased product to the customer, the transferring of funds (electronically and/or otherwise) and reconciling payment of fund transfer(s). Depending on the configuration of the host and/or depending on data associated with the particular transaction (e.g., the transaction ID, merchant ID, amount of the payment, etc.), the host device may determine whether or not the payment should be consolidated upon receipt before transmitting a payment confirmation to the merchant and/or executing a financial transaction. In some embodiments, such as those discussed in connection with FIGS. 7A, 7B and 7C regardless of whether the payment confirmations are consolidated and sent to the merchant upon receipt, an additional time delay may be built into the system to allow for further consolidation before executing a financial transaction.

FIG. 7A shows a host that may be configured to facilitate the completion of the in-person payment method for only one product at a time in accordance with some embodiments. At 702, the host can facilitate a financial transaction with a bank (such as bank 128 discussed above), in response to the host determining the payment was for a relatively large amount (e.g., for an automobile), the payment was for a product that is associated with an expiration date (e.g., an airline ticket, hotel room, etc.), and/or the payment should be paid independently (e.g., not be consolidated for any other reason). For example, the host may execute a single balance payment transaction (e.g., a single ACH transaction) based on the payment received (less, e.g., the processing fees charged by the host and/or authorizer). Additionally or alternatively, at 704, the host may transmit a confirmation message of the payment to the merchant. At 706, the merchant can confirm receipt of the payment confirmation message. Although not shown one or more other communications may also include a confirmation of receipt between the devices. Additionally, one skilled in the art would appreciate that a checksum bit and/or other know approaches may be used to confirm that the data transmission was successful.

At 708, the bank can transfer funds the merchant for the purchased product. The merchant may than complete the transaction by, for example, providing the product to the customer (including, e.g., scheduling the service to be performed, shipping the goods to the customer, among other things).

In accordance with some embodiments, FIG. 7B shows the host may determine that multiple transactions may be consolidated. In response to making such a determination (and/or as the default configuration), the host may consolidate, at 710, multiple transactions that are ready for payment processing. For example, all the transactions within a given time period (e.g., 24 hours, seven days, etc.) for a first merchant may be consolidated together into a first bundle, and all the transactions for a second merchant may be consolidated into a second bundle. The host can be configured to generate a single ACH payment request for reconciliation of each bundle of transactions, thereby minimizing ACH processing fees and/or any other type of payment type interchange rate(s).

At 712, the single consolidated balance payment can be transmitted from the host to a bank machine and/or other appropriate financial clearinghouse. Each consolidated balance payment amount can be the total of all the individual transactions that were bundled together. The consolidated balance payment may also include and/or be associated with metadata and/or any other type of corresponding data that identifies the individual transactions (e.g., data extracted from the payment confirmation messages) represented by the consolidated balance payment. The consolidated balance payment amount can be reduced by the amount of the processing fees assessed by the host and/or authorizer machines. The consolidated balance payment may also or alternatively be reduced by the processing fees, if any, of the payment machine at the physical location, if such processing fees were not collected at the physical location at the time of the payment by the customer.

The host may also transmit, at 714, a payment confirmation to the merchant. The bank machine can be configured to transmit, e.g., execute an electronic transfer of funds for the items (e.g., goods or services) to the merchant. At 716, the merchant can confirm receipt of the payment confirmation message.

At 718, the bank (which may be the host's bank) may transmit funds for the payment(s) to the merchant. For example, the host's bank may transmit funds for the payment(s) to the merchant's bank account, mail a check to the merchant, and/or otherwise facilitate payment to the merchant. Upon receipt of either the payment confirmation from the host and/or the funds from the bank, the merchant completes the remote-purchase, in-person payment transaction. For example, the merchant may cause the shipment of the goods or initiate the providing of the services paid for by the customer at the third party's payment location.

In some embodiments, rather than be configured to make a determination based on data received from the authorizer, the host may be configured to consolidate multiple transactions, execute reconciliations of in-person payments one transaction at a time, or a combination thereof.

In yet other embodiments, a hybrid approach or alternative approach to that shown in FIGS. 7A and 7B may be implemented. For example, as shown in FIG. 7C, after transmitting individual and/or consolidated payment confirmation messages to the merchant, the host may continue to wait and/or consolidate additional transactions for a single fund transfer to the bank.

FIG. 7C starts with the optional consolidation of multiple transactions at 720, similar to that discussed above in connection with 710. For example, some or all the transactions associated with a particular merchant over a first given time period (e.g., an hour, 2 hours, 24 hours, a week, etc.) may be consolidated together into a first bundle. The host can be configured to generate and transmit a consolidated payment confirmation message at 722. In some embodiments, where the host is configured to skip 720 for transactions associated with one or more merchants, the host can transmit a payment confirmation messages one at a time (e.g., as each payment is received by the host. At 716, the merchant can confirm receipt of the payment confirmation message. The merchant may then provide the product (goods and/or services) to the customer, even though the merchant may still be waiting to actually receive a transfer of funds and/or other type of payment.

Over a second period of time, which can be longer than and/or include the first period of time, the host device can be configured to consolidate, at 726, some or all the groups of transactions associated with a merchant of a group of associated merchants. For example, once a month (or any other period of time), the host can be configured to consolidate all transactions for a merchant, even if though the merchant has been provided a payment confirmation. At 728, the host can be configured to generate and transmit a combined consolidated payment confirmation message (including all the transactions that may have been logged over the second period of time), which may be confirmed at 732. The combined consolidated payment confirmation message may include, for example, a report of all the transactions that were paid for by the combined ACH payment.

A single balance payment (e.g., a single ACH payment request) for reconciliation of all the combined transactions can be generated by the host and transmitted at 730 to the bank. The longer period of time can further help minimize ACH processing fees and/or any other type of payment interchange rate(s). The combined balance payment request may also include and/or be associated with metadata and/or any other type of corresponding data that identifies the individual transactions (e.g., payments) associated with the combined balance payment. The combined balance payment amount can be reduced by the amount of the processing fees assessed by the host and/or authorizer machines. The consolidated balance payment may also or alternatively be reduced by the processing fees, if any, of the payment machine at the physical location, if such processing fees were not collected at the physical location at the time of the payment by the customer. At 734, funds may be transferred from the bank to the merchant for the purchased products.

In some embodiments, in addition to or instead of waiting for a first and/or second period of time to expire, the merchant may transmit a request that includes an instruction to the host device to consolidate and/or combine transactions and to facilitate an on-demand transfer of funds for some, all or select transactions the merchant is awaiting payment. In this regard, the merchant may control (wholly or partially) when it is paid the (entire or partial) balance owed it as well as the amount of ACH (or other type of) processing fees that are subtracted from its balance payment.

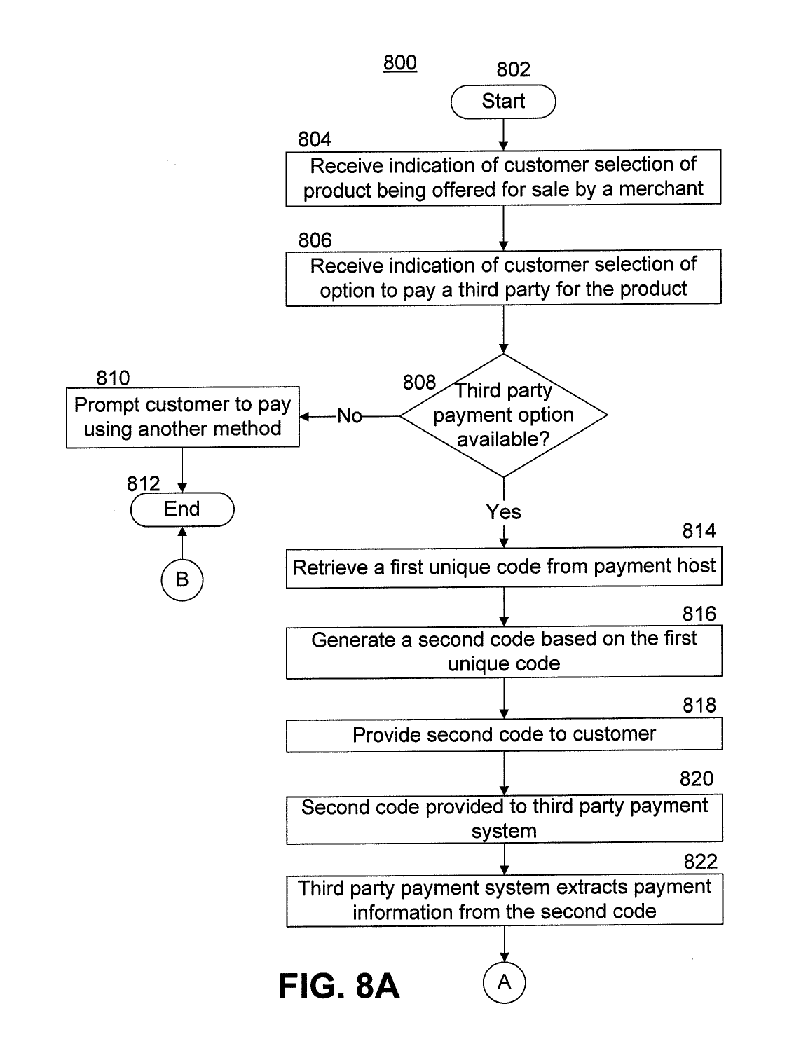

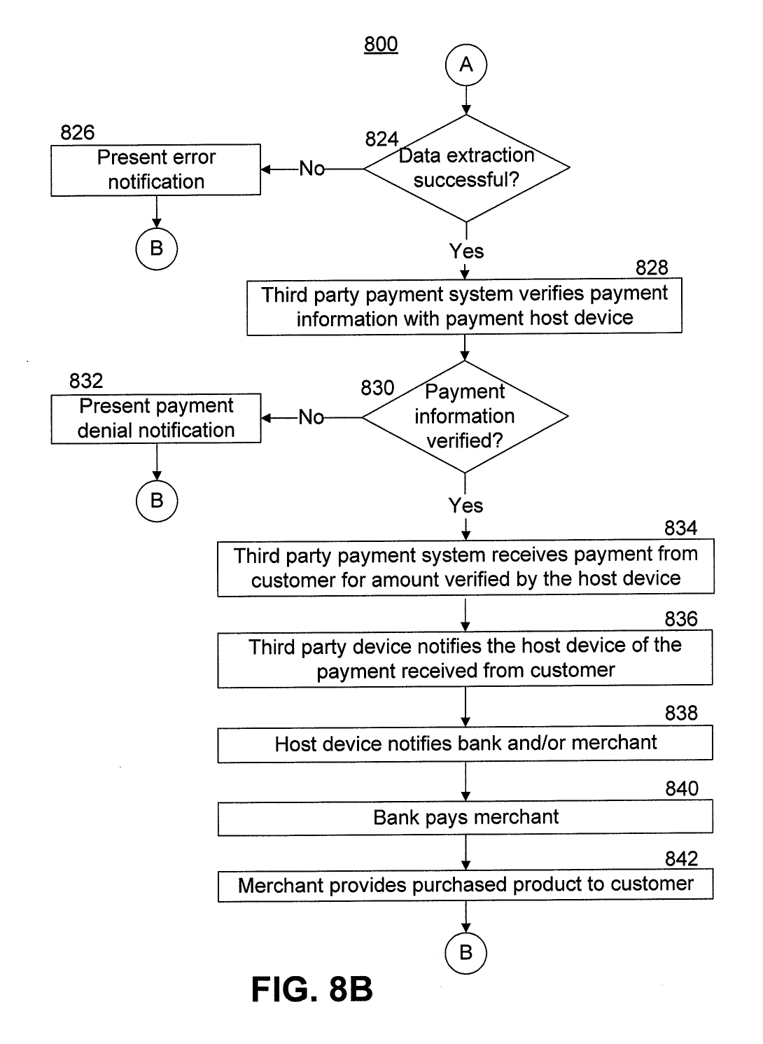

FIGS. 8A and 8B shows process 800, which is an exemplary method that may be implemented by systems in accordance with some embodiments discussed herein.

Process 800 starts at 802. At 804, a customer machine receives an indication of a customer's selection of a product being offered for sale by a merchant. For example, the customer may select a product being sold online using the customer's laptop computer.

If the third party payment method is or may be available, an option to use the third party payment method may be displayed to the customer. As described above, the third party payment method may allow a customer to pay for a product being ordered from a remote location in-person instead of paying directly to the merchant of the product being ordered. At 806, the customer machine receives an indication of the customer's selection of the option to pay a third party for the product.

At 808, a determination is made as to whether or not the third party payment option is available. In some embodiments, 808 may precede 806.

In response to determining the third party payment option is unavailable (e.g., after the customer has selected to use the third party payment option as shown in FIG. 8A), the customer may be prompted at 810 to pay using another method. The third party payment method may then end at 812. In some embodiments where a determination as to the availability of the third party payment option is made prior to 806 (rather than after 806), the system may be configured to not provide a selectable option to pay using the third party payment method (e.g., the option may be grayed, not displayed, or otherwise unavailable).

In response to determining the third party payment option is available at 808, the merchant's device may retrieve a unique code from a payment host. At 816, the unique code may be used to generate a second code. The second code may be, for example, a barcode that may be transmitted to the customer's machine(s) at 818. For example, the barcode may be sent in an email message, as a printable website, and/or by any other means of conveying a code to the customer. In some embodiments, as mentioned herein, any other type of code may be provided to the customer. For example, the second code may be configuration data that enables the customer to program an RFID tag (included in a credit card or elsewhere) with the first unique code. As another example, rather than or in addition to generating a second code, the merchant's system may simply relay the first unique code (e.g., random 13 digit alphanumeric code) to the customer via text message, email, and/or otherwise. To avoid overcomplicating the discussion of FIGS. 8A and 8B, a generic code is hereinafter referenced. The generic code may be conveyed physically, electrically or otherwise to the third party payment system.

In some embodiments, the second code of 818 may be included in a bill mailed to the customer. For example, a utility and/or other type of company may include a barcode on a customer's bill. That barcode may allow the customer to pay the company through a third party.

At 820, the customer may print and deliver or otherwise provide (e.g., email, text message, speak, etc.) the code received at 818 to a third party payment system (such as payment system 126 discussed herein). For example, if the customer receives a barcode or other type of code in an email message to be printed, but does not have access to a printer, the customer may forward the email message received at 818 to a payment location the customer intends to visit to pay for the product.

At 822, the third party payment system extracts payment information from the code (before or after the customer arrives at the third party payment location). For example, a barcode scanner may read a barcode and generate a numeric or any other type of code based on the barcode. In some embodiments, the code extracted from the barcode may include data related to the transaction (e.g., purchase amount, transaction ID, etc.). In other embodiments, the extracted code is only a reference number used by the host system to retrieve data related to the transaction, including the purchase amount the customer is to pay in-person at the payment location.

Process 800 continues in FIG. 8B. At 824, a determination is made as to whether or not the data extraction of the first unique code and/or other transaction data, sometimes referred to herein as “payment information,” from the second code was successful. In response to determining the first code and/or other payment information was unsuccessfully extracted from the second code (e.g., the second code is fraudulent, flawed, and/or expired), the payment system may present an error notification may be presented at 826, and process 800 may return to 812 of FIG. 8A and end.

The determination of 824 may be made by the payment system, a host system, an authorizer machine, and/or any other system. In response to determining the payment information was successfully extracted from the second code at 824, the third party payment system verifies, at 828, the extracted payment information with a payment host device (such as payment host 114). For example, in some embodiments, the host device may verify the extracted data accurately depicts what the customer owes.

In other embodiments, the host device may use the data provided by the payment system to retrieve the amount the customer owes and return the purchase price to the payment system. Sometimes, before the payment device can retrieve the amount the customer owes, the payment system may need to determine whether or not the second code is associated with data stored at or generated by the host. For example, in response to one or more system components (see, e.g., FIGS. 1A-4) determining that the code received by the payment system is a second code based on data generated by the system (e.g., the host device), the host device may be configured to retrieve from a system storage device (e.g., database 116 and/or memory device 404) the amount the customer owes and return the purchase price to the payment system.

In some other embodiments, the code received by the payment system may be associated with data not generated by or that is otherwise unknown to the host and/or other system components. In such embodiments, the system may communicate with a remote system associated with the received code in response to one or more system component(s) determining that the received code is a non-host generated code (e.g., a barcode printed on a utility company bill, and/or any other type of code generated by any other type of merchant absent any interaction with the host device during the offer for sale and acceptance process). For example, if the received code starts with or otherwise includes a number that is associated with a product provider that generates codes without the assistance of the host (e.g., the payment system may be configured to maintain and store a table that associates product providers with portions of the non-host codes they generate), the system can communicate with the product provider's system and obtain the purchase price the customer is to pay. Alternatively, if the price is unable to be determined for a non-host generated code received by the payment system, the payment system may determine whether or not the product provider associated with the code participates in the third party payment method (e.g., by referencing a table stored by the system) and, if so, accept payment and notify the product provider of the payment as discussed herein.

At 830, a determination is made as to whether or not the payment information was verified. In response to determining the payment information in unverifiable, process 800 proceeds to 832 at which a payment denial notification is presented. For example, the payment system may indicate that the host has declined to execute the transaction because the code could not be verified. Process 800 may return to 812 of FIG. 8A and end.

In response to determining at 830 that the payment information has been verified, the third party payment system receives payment, at 834, from customer for amount verified by host device. The third party payment system may be configured to receive cash, credit card, check, debit card, and/or any other form of payment.

At 836, the third party device notifies host device of payment received from customer. If, for example, there is an interruption in the transmission at 836 (and/or at any other time), the system may wait until communications are restored and then proceed accordingly. At 838, the host device may save the transaction for later processing (e.g., after consolidating) and/or notify the bank and/or the merchant and/or conduct other backend system operations, such as those discussed above. At 840, the bank may transfer funds to the merchant and/or notify the merchant of the money added to the merchant's account at the bank. The merchant may then provide the purchased product to the customer at 842. Process 800 may then return to 812 of FIG. 8A and end.

The third party payment method discussed herein may be applied to any product or service purchase that is made through any type of merchant, including any type of electronic purchasing system. In addition to the embodiments discussed above, a similar method can be used to pay public utilities (e.g., such as an electric company), private service providers (such as, e.g., software and electronic media developers, cellular phone company, etc.) and/or other organizations or people that that (routinely, periodically, or otherwise) issue invoices to customers and/or charge customer credit cards. As part of the invoicing process, the utility or other type of service provider may include a barcode or other type of code. The customer may then use the barcode as described in relation to the embodiments discussed herein, but excluding some of the method functions (e.g., those that involve generating the code).

Additionally, many modifications and other embodiments of the inventions set forth herein will come to mind to one skilled in the art to which these inventions pertain having the benefit of the teachings presented in the foregoing descriptions and the associated drawings. For example, in addition to the payment being used to provide a service, a lack of payment can be used to disable, turn off, or otherwise stop providing a service. A customer may receive, for example, a service for free for a predetermined period of time and, if the customer pays a third party for the service within the predetermined period of time, the customer may continue to receive the service (even if, e.g., the service provider is not paid by the third party till after the predetermined period of time has elapsed). Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating the purchase of a product, comprising:
receiving, from a merchant machine, purchase information for a product offered for sale to a customer by a merchant associated with the merchant machine;
in response to receiving the purchase information, generating a code;
sending the code to the merchant machine;
receiving the code after the code is extracted by a payment system from the customer at a payment location, wherein the payment system is different than the merchant machine and the payment system is independent from the merchant;
receiving a payment confirmation of an amount paid by the customer at the payment location, wherein the payment confirmation confirms payment of at least a portion of a purchase price;
transmitting, to the merchant, a payment confirmation message that identifies the at least the portion of the purchase price paid;
calculating a payment balance by subtracting a processing fee from the amount paid;
generating a consolidated payment by consolidating the payment balance with one or more other payment balances for the merchant;
facilitating a single payment of the consolidated payment to the merchant;
generating a report identifying each purchase associated with the consolidated payment; and
transmitting the report to the merchant.

2. The method of claim 1 further comprising, in response to receiving the payment confirmation, transmitting a payment confirmation message that identifies at least a portion of the purchase information.

3. The method of claim 1 further comprising:
in response to receiving the code extracted by the payment system, retrieving from a storage device a purchase price associated with the code; and
sending the purchase price to the payment location.

4. The method of claim 1 further comprising:
in response to receiving the code extracted by the payment system, retrieving from a storage device a purchase price associated with the code; and
determining from the payment confirmation whether the at least the portion of the purchase price that was paid is sufficient to initiate providing of the product.

5. The method of claim 4 further comprising, in response to determining from the payment confirmation that the at least the portion of the purchase price paid is sufficient to initiate providing of the product, transmitting a payment confirmation message that identifies at least a portion of the purchase information.

6. The method of claim 4 further comprising, in response to determining from the payment confirmation that the at least the portion of the purchase price paid is insufficient to initiate providing of the product, sending a message to the payment location indicating that an additional payment is required before providing the product is initiated.

7. The method of claim 1 further comprising determining from the payment confirmation that the at least the portion of the purchase price paid is at least an amount of the purchase price associated with the code.

8. The method of claim 1, wherein receiving the code from the payment location comprises receiving the code from a gas station that is otherwise unaffiliated with the merchant.

9. The method of claim 1, wherein generating the code, comprises generating the code such that the code is configured to serve as the basis for a barcode to be scanned at the payment location.

10. The method of claim 1 further comprising calculating the processing fee by adding a host processing fee with a payment system processing fee.

11. A method for facilitating the purchase of a product, comprising:
receiving, from a first merchant machine, first purchase information for a first product offered for sale by a first merchant associated with the first merchant machine;
in response to receiving the first purchase information, generating a host code;
sending the host code to the first merchant machine;
receiving the host code after the host code is extracted by a payment system at a payment location, wherein the payment system is different than the first merchant machine and the payment system is independent from the first merchant;
receiving a first payment confirmation of a first amount paid at the payment location, wherein the first payment confirmation confirms payment of at least a portion of a first purchase price associated with the host code;
transmitting, to the first merchant, a first payment confirmation message that identifies the at least the portion of the first purchase price paid;
facilitating a first payment, to the first merchant, of at least some of the first purchase price paid;
receiving a non-host code;
verifying the non-host code, wherein verifying the non-host code includes contacting a second merchant;
receiving a second payment confirmation of a second amount paid at the payment location, wherein the second payment confirmation confirms payment of at least a portion of a second purchase price associated with the non-host code;
transmitting, to the second merchant, a second payment confirmation message that identifies the at least the portion of the second purchase price paid; and
facilitating a second payment, to the second merchant, of at least some of the second purchase price paid.

12. A system for facilitating the purchase of a product, comprising:
communications circuitry:
at least one processor, the at least one processor configured to:
receive with the communications circuitry, from a merchant machine, purchase information for a product offered for sale to a customer by a merchant associated with the merchant machine;
in response to receiving the purchase information, generate a code;
cause the code to be sent to the merchant machine;
receive the code after the code is extracted by a payment system from the customer at a payment location, wherein the payment system is different than the merchant machine and the payment system is independent from the merchant;
receive a payment confirmation of an amount paid by the customer at the payment location, wherein the payment confirmation confirms payment of at least a portion of the purchase price;
calculate a payment balance by subtracting a processing fee from the amount paid;
generate a consolidated payment by consolidating the payment balance with one or more other payment balances;
facilitate a single payment of the consolidated payment to the merchant;
generate a report identifying each purchase associated with the consolidated payment; and
transmit the report to the merchant.

13. The system of claim 12, wherein the at least one processor is further configured to, in response to receiving the payment confirmation, transmit a payment confirmation message that identifies at least a portion of the purchase information.

14. The system of claim 12 further comprising:
a storage device; and
the at least one processor is further configured to:
in response to receiving the code extracted by the payment system, retrieve from a storage device a purchase price associated with the code; and
sending the purchase price to the payment location.

15. The system of claim 12, wherein the at least one processor is further configured to:
in response to receiving the code extracted by the payment system, retrieve from a storage device a purchase price associated with the code; and
determine from the payment confirmation whether at least a portion of the purchase price was paid that is sufficient to initiate providing of the product.

16. The system of claim 15, wherein the at least one processor is further configured to initiate providing of the product, in response to determining from the payment confirmation that the at least the portion of the purchase price paid is sufficient to initiate providing of the product.

17. The system of claim 15, wherein the at least one processor is further configured to, in response to determining from the payment confirmation that the at least the portion of the purchase price paid is insufficient to initiate providing of the product, transmitting a payment confirmation message that identifies at least a portion of the purchase information.

18. The system of claim 12, wherein the at least one processor is further configured to determine from the payment confirmation the amount paid is at least a purchase price associated with the code.

19. The system of claim 12, wherein the payment system comprises gas station system.

20. The system of claim 12, wherein the code is configured to serve as the basis for a barcode to be scanned at the payment location.

21. The system of claim 12, wherein the at least one processor is further configured to calculate the processing fee by adding a host processing fee with a payment system processing fee.
